(19) United States
(12) Patent Application Publication
(10) Pub. No.: US 2007/0286967 A1
(43) Pub. Date: Dec. 13, 2007

(54) PLASMA PROCESSING APPARATUS AND PLASMA PROCESSING METHOD

(75) Inventors: Shinji Ide, Hyogo (JP); Masaru Sasaki, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/575,530

(22) PCT Filed: Sep. 16, 2005
(86) PCT No.: PCT/JP05/17146

§ 371 Date: Mar. 19, 2007

(30) Foreign Application Priority Data
Sep. 17, 2004 (JP) 2004-271732

(51) Int. Cl. H05H 1/24; C23F 1/00

(52) U.S. Cl. 427/569; 156/345.26; 156/345.3

(57) ABSTRACT

A plasma processing apparatus 100 includes an upper plate 60 and a lower plate 61 disposed above a susceptor 2. The upper plate 60 and lower plate 61 are made of a heat resistant and insulative material, such as quartz. The two plates are disposed in parallel with each other with a predetermined gap of, e.g., 5 mm interposed therebetween. The two plates have a plurality of through holes 60a and 61a formed therein and positionally shifted from each other. The two plates are disposed in an overlapped state such that the through holes 61a of the lower plate 61 are not aligned with the through holes 60a of the upper plate 60.

### TECHNICAL FIELD

The present invention relates to a plasma processing apparatus for processing a target substrate, such as a semiconductor substrate, by use of plasma.

### BACKGROUND ART

As regards high speed logic devices in recent years, inter-level insulating films tend to have a lower dielectric constant (progress in Low-k) to decrease the parasitic capacitance between interconnection lines. Accordingly, it has been studied to form Low-k films from porous materials having high porosity, for VLSI (very large scale integrated circuit) devices, and particularly for the 65-nm technical node generation or thereafter. In general, since porous Low-k films are poor in mechanical strength, film peeling may occur when planarization is performed by CMP after a Low-k film is formed and Cu is embedded. In light of this, the Low-k film needs to be processed in advance by a hardening process (curing) which is performed by, e.g., a heat process, UV process, or electron beam process. There has been proposed a method as a curing process by use of plasma, in which a plasma processing apparatus of the parallel-plate type is used to perform a plasma process on a Low-k film (for example, Patent Document 1).

[Patent Document 1]

Jpn. Pat. Appln. KOKAI Publication No. 2004-103747

### DISCLOSURE OF INVENTION

As disclosed in Patent Document 1, where curing of a Low-k film is performed by a plasma process, the mechanical strength of the film is improved. However, in the process of curing, a problem arises in that the dielectric constant of the Low-k film is increased. The present inventors studied the causes of this problem, and have found the following phenomenon. Specifically, plasma ion components detach alkoxy groups and alkyl groups, such as methyl groups, present in a Low-k film, thereby developing polarization of molecules in the film.

Accordingly, an object of the present invention is to provide a plasma processing apparatus and plasma processing method that can prevent or suppress ill effects of plasma ion components on a Low-k film when a plasma process is performed for curing.

In order to solve the problem described above, according to a first aspect of the present invention, there is provided a plasma processing apparatus comprising:

a process chamber configured to perform a plasma process on a target substrate;

a substrate table configured to place the target substrate thereon inside the process chamber; and

a selection passage implement disposed above the substrate table and configured to suppress passage of ions in plasma and preferentially allow hydrogen radicals in the plasma to pass therethrough.

In the first aspect described above, plasma is preferably supplied from an upper position inside the process chamber through the selection passage implement toward the target substrate placed on the substrate table. The selection passage implement preferably includes two or more plates each having a plurality of through openings formed therein, the plates being arranged such that the through openings of the plates are not aligned with each other.

According to a second aspect of the present invention, there is provided a plasma processing apparatus comprising:

a process chamber configured to perform a plasma process on a target substrate;

a substrate table configured to place the target substrate thereon inside the process chamber; and

two or more plates disposed above the substrate table and each having a plurality of through openings formed therein, the plates being arranged such that the through openings of the plates are not aligned with each other.

In the second aspect described above, plasma is preferably supplied from an upper position inside the process chamber through the plates toward the target substrate placed on the substrate table.

According to a third aspect of the present invention, there is provided a plasma processing apparatus comprising:

a process chamber configured to perform a plasma process on a target substrate;

a substrate table configured to place the target substrate thereon inside the process chamber; and

an exhaust system configured to decrease pressure inside the process chamber;

a gas supply system configured to supply a gas into the process chamber;

a planar antenna disposed at an upper position of the process chamber and connected to a microwave generation unit outside the process chamber the planar antenna having a plurality of slots formed therein to supply microwaves into the process chamber to generate plasma; and

two or more plates disposed between the planar antenna and the substrate table and each having a plurality of through openings formed therein, the plates being arranged such that the through openings of the plates are not aligned with each other.

In the third aspect described above, plasma is preferably supplied from an upper position inside the process chamber through the plates toward the target substrate placed on the substrate table.

In the plasma processing apparatus according to each of the first to third aspects described above, the through openings are preferably through holes or slits. Each of the plates is preferably formed of an insulative material.

According to a fourth aspect of the present invention, there is provided a plasma processing method performed in a plasma processing apparatus configured to perform a plasma process on a target substrate placed on a substrate table inside a process chamber, the method comprising:

supplying plasma from an upper position inside the process chamber toward the target substrate placed on the substrate table, while using a selection passage implement disposed above the substrate table to suppress passage of ions in the plasma and preferentially allow hydrogen radicals in the plasma to pass therethrough.

In the fourth aspect described above, the plasma process is preferably arranged to preferentially cause hydrogen radicals to act on a Low-k film formed on the target substrate, thereby performing a hardening process on the Low-k film. The Low-k film is preferably an SiOCH family film. A process gas containing a rare gas and hydrogen is preferably used.

According to a fifth aspect of the present invention, there is provided a control program for execution on a computer used for a plasma processing apparatus configured to perform a plasma process on a target substrate placed on a substrate table inside a process chamber wherein the control program, when executed by the computer controls the apparatus to perform a plasma processing method comprising:

supplying plasma from an upper position inside the process chamber toward the target substrate placed on the substrate tables while using a selection passage implement disposed above the substrate table to suppress passage of ions in the plasma and preferentially allow hydrogen radicals in the plasma to pass therethrough; and

preferentially causing hydrogen radicals to act on a Low-k film formed on the target substrate, thereby performing a hardening process on the Low-k film.

According to a fifth aspect of the present invention, there is provided a computer storage medium that stores a control program for execution on a computer, used for a plasma processing apparatus configured to perform a plasma process on a target substrate placed on a substrate table inside a process chamber, wherein the control program, when executed by the computer, controls the apparatus to perform a plasma processing method comprising:

supplying plasma from an upper position inside the process chamber toward the target substrate placed on the substrate table, while using a selection passage implement disposed above the substrate table to suppress passage of ions in the plasma and preferentially allow hydrogen radicals in the plasma to pass therethrough; and

preferentially causing hydrogen radicals to act on a Low-k film formed on the target substrate, thereby performing a hardening process on the Low-k film.

According to a seventh aspect of the present invention, there is provided a plasma processing apparatus comprising:

a process chamber configured to be vacuum-exhausted and to perform a process on a target substrate by use of plasma;

a substrate table configured to place the target substrate thereon inside the process chamber;

a selection passage implement disposed above the substrate table and configured to suppress passage of ions in the plasma and preferentially allow hydrogen radicals in the plasma to pass therethrough; and

a control section configured to perform a plasma processing method for preferentially causing hydrogen radicals to act on a Low-k film formed on the target substrate, thereby performing a hardening process on the Low-k film.

The plasma processing apparatus according to the present invention comprises a selection passage implement configured to suppress passage of ions in plasma and preferentially allow hydrogen radicals in the plasma to pass therethrough. Consequently, for example, it is possible to remove the influence of ions onto a film formed on a wafer treated as the target substrate, and to perform curing of the film by hydrogen radicals without increasing the dielectric constant of the film.

Where the selection passage implement comprises two or more plates each having a plurality of through openings formed therein, and the plates are arranged such that the through openings of the plates are not aligned with each other almost all ions can be blocked off by a simple structure.

Further, the plasma processing method according to the present invention can reliably perform a curing process of the film by use of the plasma processing apparatus described above.

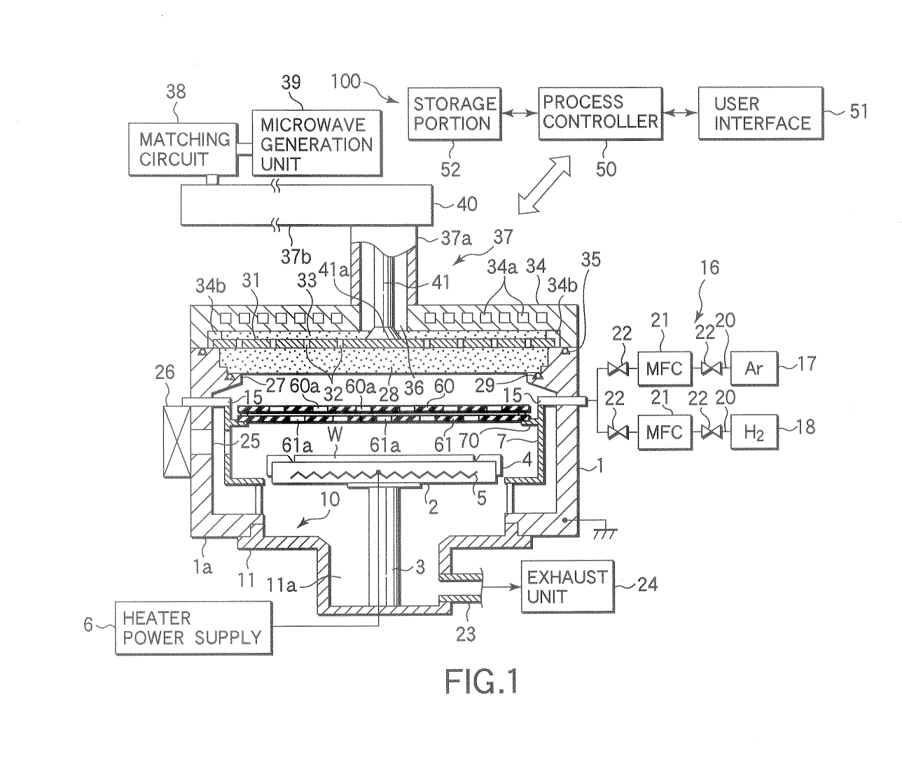

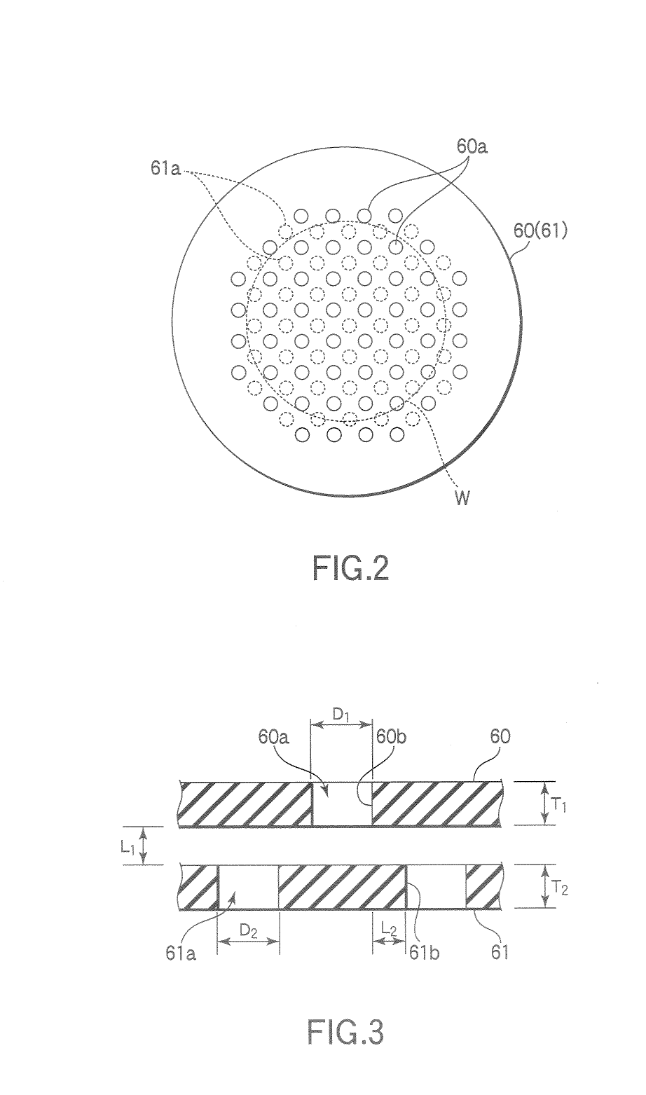

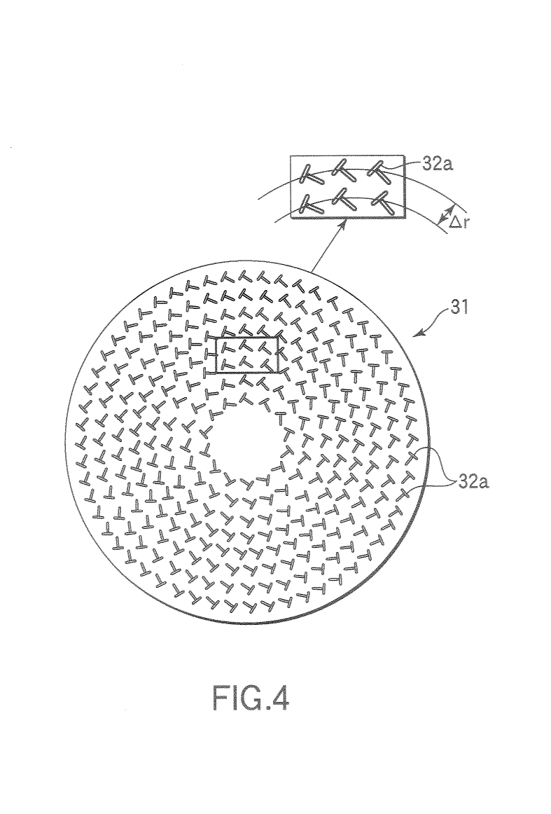

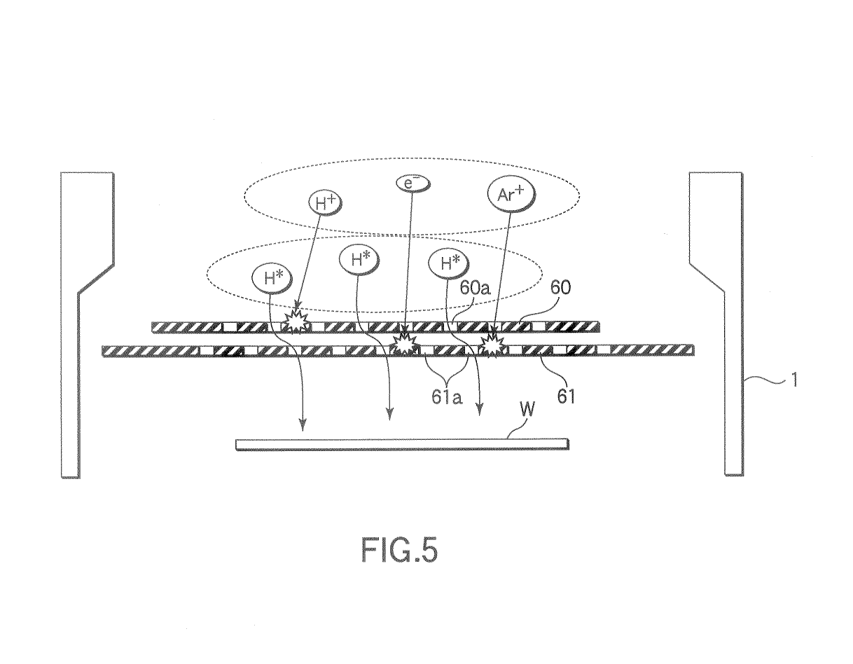

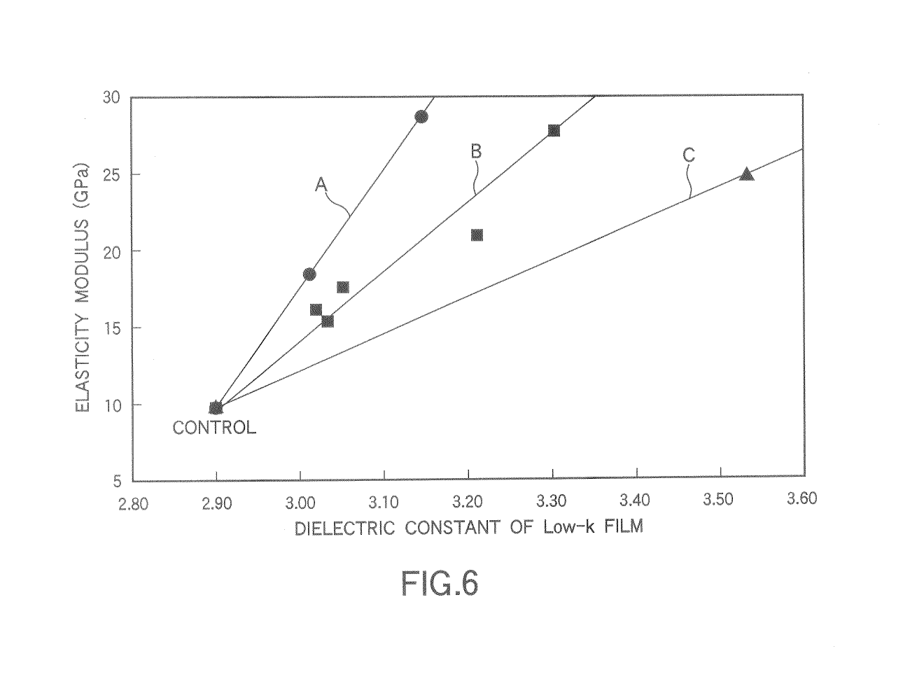

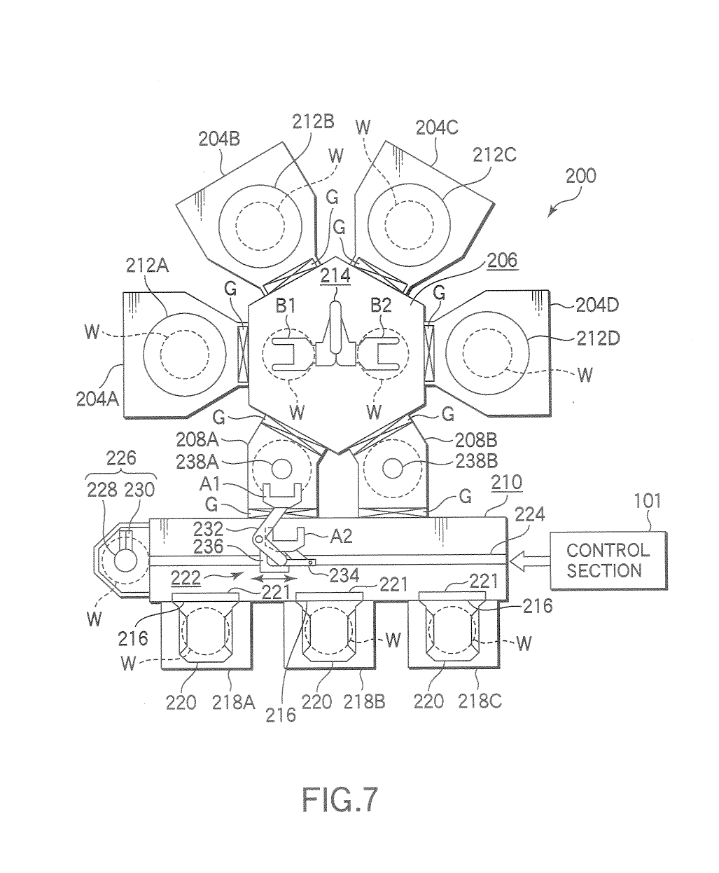

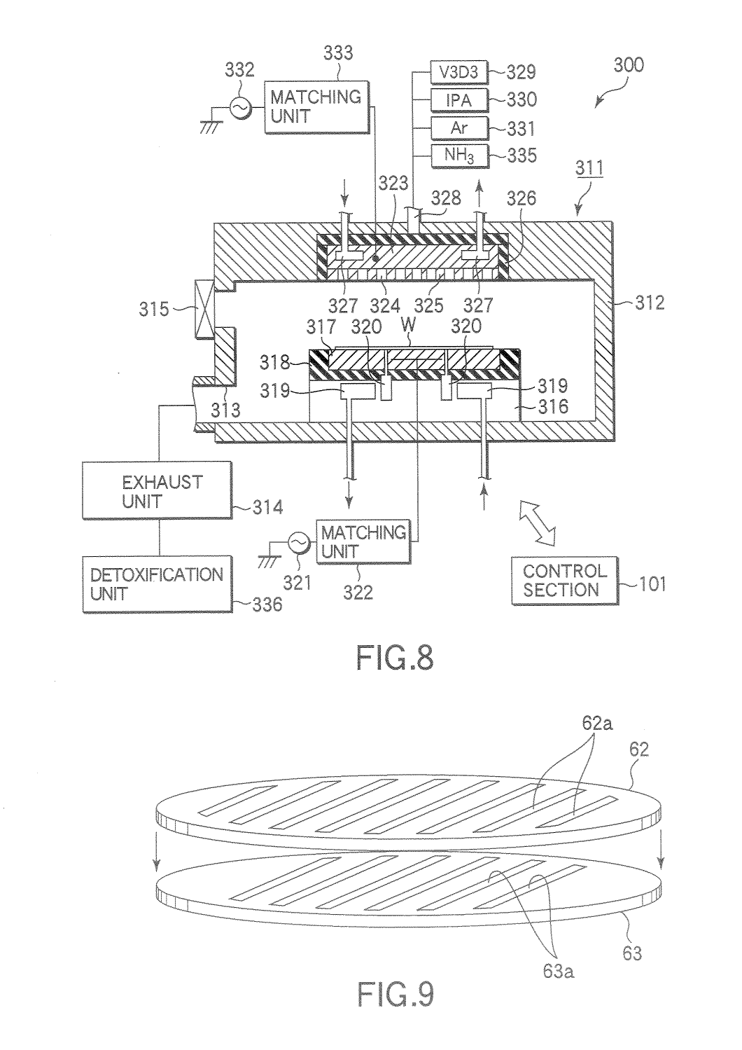

### BRIEF DESCRIPTION OF DRAWINGS

[FIG. 1] This is a sectional view schematically showing an example of a plasma processing apparatus according to an embodiment of the present invention.

[FIG. 2] This is a plan view for explaining plates.

[FIG. 3] This is a sectional view of a main portion for explaining the plates.

[FIG. 4] This is a view for explaining a planar antenna member.

[FIG. 5] This is a principle view for explaining an effect of the upper and lower plates.

[FIG. 6] This is a graph showing the relationship between the dielectric constant and elasticity modulus of a film.

[FIG. 7] This is a view schematically showing the arrangement of a plasma processing system.

[FIG. 8] This is a sectional view schematically showing the arrangement of a plasma CVD apparatus of the parallel-plate type.

[FIG. 9] This is a view for explaining upper and lower plates according to another embodiment.

### BEST MODE FOR CARRYING OUT THE INVENTION

Preferable embodiments of the present invention will now be described with reference to the accompanying drawings. FIG. 1 is a sectional view schematically showing an example of a plasma processing apparatus according to an embodiment of the present invention. This plasma processing apparatus utilizes an RLSA (Radial Line Slot Antenna) plasma generation technique, in which microwaves are supplied from a planar antenna having a plurality of slots into a process chamber to generate plasma, so that microwave plasma is generated with a high density and a low electron temperature.

This plasma processing apparatus 100 can proceed with a plasma process at a low temperature of 500° C. or less and free from damage to the underlying film and so forth. Further this apparatus is good in plasma uniformity and thus can realize process uniformity comparable to those attained by plasma processing apparatuses of the ICP type and parallel-plate type. Accordingly, the plasma processing apparatus 100 is preferably usable for, e.g., a curing process of a Low-k film.

This plasma processing apparatus 100 includes an essentially cylindrical chamber 1, which is airtight and grounded. The bottom wall 1a of the chamber 1 has a circular opening portion 10 formed essentially at the center, and is provided with an exhaust chamber 11 communicating with the opening portion 10 and extending downward.

The chamber 1 is provided with a substrate table or susceptor 2 located therein and made of a ceramic, such as AlN, for supporting a target substrate such as a wafer W, in a horizontal state. The susceptor 2 is supported by a cylindrical support member 3 made of a ceramic, such as AlN, and extending upward from the center of the bottom of the exhaust chamber 11. The susceptor 2 is provided with a guide ring 4 located on the outer edge to guide the wafer W. The susceptor 2 is further provided with a heater 5 of the resistance heating type built therein. The heater 5 is supplied with a power from a heater power supply 6 to heat the susceptor 2, thereby heating the target object or wafer W. For example, the heater 5 can control the temperature within a range of from room temperature to 800° C. A cylindrical liner 7 made of quartz is attached along the inner wall of the chamber 1.

The susceptor 2 is provided with wafer support pins (not shown) that can project and retreat relative to the surface of the susceptor 2 to support the wafer W and move it up and down.

An upper plate 60 and a lower plate 61 are located above the susceptor 2, and are configured to trap ions generated in plasma or to serve as baffle plates. Each of the upper and lower plates 60 and 61 is made of a dielectric material or insulative material, such as quartz, sapphire, a ceramic, e.g., SiN, SiC, Al₂O₃, or AlN, or a combination thereof, and preferably of quartz. The upper plate 60 and lower plate 61 are partly coupled to each other near the peripheral edges, so that the two plates 60 and 61 are separated from and in parallel with each other with a predetermined gap therebetween (as described later). The outer peripheral portion of the lower plate 61 is engaged with and supported by a support portion 70 projecting inward from the liner 7 and extending all around within the chamber 1.

The plates 60 and 61 are preferably disposed at a position close to the wafer W, and, for example, the distance between the bottom of the lower plate 61 and the wafer W is preferably set to be 3 to 20 mm, and more preferably to be about 10 mm. In this case, for example, the distance between the top of the upper plate 60 and the bottom of a microwave transmission plate 28 (described later) is preferably set to be 20 to 50 mm, and more preferably to be about 35 mm.

The upper plate 60 has a plurality of through holes 60a formed therein, and the lower plate 61 also has a plurality of through holes 61a formed therein. FIGS. 2 and 3 are views showing the upper and lower plates 60 and 61 in detail. FIG. 2 shows the overlapped upper and lower plates 60 and 61 viewed from above. FIG. 3 shows a cross-section of a main portion of the overlapped upper and lower plates 60 and 61.

For example, each of the thickness (T1) of the upper plate 60 and the thickness (T2) of the lower plate 61 is preferably set to be about 2 to 10 mm, and more preferably to be about 5 mm. However, the thicknesses T1 and T2 of the upper and lower plates 60 and 61 are not necessarily set to be the same.

The gap (L1) between the two plates 60 and 61 is preferably set to be about 3 to 10 mm, and more preferably to be 5 mm.

As shown in FIG. 2, the through holes 60a of the upper plate 60 and the through holes 61a of the lower plate 61 are essentially uniformly arrayed to cover the seat area of the wafer W indicated with a broken line. As shown in FIGS. 2 and 3, the positions of the through holes 61a of the lower plate 61 are shifted from the positions of the through holes 60a of the upper plate 60, so that the through holes 61a are not aligned with the through holes 60a where the two plates 60 and 61 are set in the overlapped state. In other words, the through holes 60a and through holes 61a are arranged such that they cannot define any opening rectilinearly connecting a position above the upper plate 60 to the wafer surface.

The diameter D1 of the through holes 60a and the diameter D2 of the through holes 61a can be set at an arbitrary value, and, for example, set at about 5 mm in this embodiment. In each of the plates, the through holes 60a or 61a may have different sizes depending on the position. The through holes 60a of the upper plate 60 and the through holes 61a of the lower plate 61 may have different sizes from each other. The array pattern of each set of the through holes 60a and 61a can be any pattern such as a concentric, radial, or spiral pattern, as long as the positions of holes are not aligned between the upper and lower plates 60 and 61.

The positional shift between the through holes 60a and through holes 61a, i.e., the distance L2 between the wall 60b of the through holes 60a of the upper plate 60 and the wall 61b of the through holes 61a of the lower plate 61, may be determined to be optimum with reference to the relationship of the distance L2 relative to the gap L1 between the upper and lower plates 60 and 61.

Specifically, in order to preferentially allow radicals in plasma to pass therethrough and to block off ions thereof, L2 needs to be relatively larger with an increase in the gap L1 between the upper and lower plates 60 and 61. On the other hand, with a decrease in L1, L2 can be relatively smaller while providing an effect as a radical selection passage implement. In addition to the relationship between L1 and L2, the following factors may be comprehensively considered to maximize the effect of selecting radicals and blocking ions. These factors are the thicknesses T1 and T2 of the upper and lower plates 60 and 61 (i.e., the heights of the walls 60b and 61b defining surfaces that extend in parallel with a direction in which radicals pass through), and the diameters D1 and D2 of the through holes 60a and 61a, as well as the shape and array pattern of the through holes 60a and 61a, and the set positions of the upper and lower plates 60 and 61 (the distance from the wafer W).

As shown in FIG. 1, a gas introducing member 15 having an annular structure is attached at the sidewall of the chamber 1 and is connected to a gas supply system 16. The gas introducing member may have a shower structure. The gas supply system 16 includes an Ar gas supply source 17 for supplying argon gas and an H₂ gas supply source 18 for supplying hydrogen gas. The gases are supplied from the sources through respective gas lines 20 to the gas introducing member 15 and are delivered from the gas introducing member 15 into the chamber 1. The gas introducing member 15 and gas supply system 16 constitute gas supply means.

Each of the gas lines 20 is provided with a mass-flow controller 21 and two switching valves 22 one on either side of the controller 21.

Where plasma curing is performed on a Low-k film on the wafer W, the process gas comprises a hydrogen-containing gas. Specifically, the process gas is preferably a gas prepared by combining hydrogen at a predetermined ratio with an inactive gas such as a rare gas selected from krypton, xenon, helium, and argon.

The sidewall of the exhaust chamber 11 is connected to an exhaust unit 24 including a high speed vacuum pump through an exhaust line 23. The exhaust unit 24 can be operated to uniformly exhaust the gas from inside the chamber 1 into the space 11a of the exhaust chamber 11, and then out of the exhaust chamber 11 through the exhaust line 23. The exhaust line 23 and exhaust unit 24 constitute exhaust means. Consequently, the inner pressure of the chamber 1 can be decreased at a high speed to a predetermined vacuum level, such as 0.133 Pa.

The chamber 1 has a transfer port 25 formed in the sidewall and provided with a gate valve 26 for opening/closing the transfer port 25. The wafer W is transferred between the plasma processing apparatus 100 and an adjacent transfer chamber (not shown) through the transfer port 25.

The chamber 1 has an opening portion at the top, and is provided with an annular support portion 27 along the periphery of the opening portion. A microwave transmission plate 28 is airtightly mounted on the support portion 27 through a seal member 29 and is made of a dielectric material, such as quartz to transmit microwaves. The interior of the chamber 1 is thus held airtight. The support portion 27 that supports the microwave transmission plate 28 is made of, e.g., Al alloy or stainless steel.

As a component on the upper side of the plasma processing apparatus 100, a circular planar antenna member 31 is located above the microwave transmission plate 28 to face the susceptor 2. The planar antenna member 31 is mounted on the microwave transmission plate 28, and a retardation material is further disposed to cover the top of the planar antenna member 31. The planar antenna member 31 and retardation material are fixed at the periphery by a presser member 34b. A shield lid 34 is disposed to cover the retardation material, and is supported on the upper end of the sidewall of the chamber 1

The planar antenna member 31 is a circular plate made of a conductive material and is formed to have, e.g., a diameter of 300 to 400 mm and a thickness of 0.1 to several mm (for example, 0.5 mm) for 8-inch wafers W. The shape of the planar antenna member 31 is not limited to a circular shape, and it may be polygonal shape, such as a rectangular shape. More specifically, the planar antenna member 31 is formed of, e.g., a copper plate or aluminum plate with the surface plated with gold. The planar antenna member 31 has a number of microwave radiation holes 32 formed therethrough and arrayed in a predetermined pattern. For example, as shown in FIG. 4, the microwave radiation holes 32 are formed of long grooves or slots 32a, wherein the slots 32a may be arranged such that adjacent slots 32a form a T-shape, and T-shapes are arrayed on a plurality of concentric circles defined at intervals Δr in the radial direction. The length and array intervals of the slots 32a are determined in accordance with the wavelength of radio frequency generated by a microwave generation unit 39. The microwave radiation holes 32 (slots 32a) may have another shape, such as through holes of a circular shape. The array pattern of the microwave radiation holes 32 (slots 32a) is not limited to a specific one, and, for example, it may be spiral or radial other than concentric.

As described above, the retardation material having a dielectric constant larger than that of vacuum is located on the top of the planar antenna member 31. The planar antenna member 31 and retardation material are covered with the shield lid 34 located at the top of the chamber 1 and made of a metal material, such as aluminum or stainless steel. A seal member 35 is interposed between the top of the chamber 1 and the shield lid 34 to seal this portion. The shield lid 34 is provided with a plurality of cooling water passages 34a formed therein. Cooling water is supplied to flow through the cooling water passages to cool the planar antenna member 31 microwave transmission plate 28 retardation material and shield lid 34. The shield lid 34 is grounded.

The shield lid 34 has an opening portion 36 formed at the center of the upper wall and connected to a wave guide tube 37. The wave guide tube 37 is connected to the microwave generation unit 39 at one end through a matching circuit 38. The microwave generation unit 39 generates microwaves with a frequency of, e.g. 2.45 GHz, which are transmitted through the wave guide tube 37 to the planar antenna member 31. The microwaves may have a frequency of 8.35 GHz or 1.98 GHz.

The wave guide tube 37 includes a coaxial wave guide tube 37a having a circular cross-section and extending upward from the opening portion 36 of the shield lid 34 and a rectangular wave guide tube 37b connected to the upper end of the coaxial wave guide tube 37a and extending in a horizontal direction. The rectangular wave guide tube 37b includes a mode transducer 40 at the end connected to the coaxial wave guide tube 37a. The coaxial wave guide tube 37a includes an inner conductor 41 extending at the center. A flared portion 41a is formed at the lower end portion of the inner conductor 41. The inner conductor is connected and fixed to the center of the planar antenna member 31 through a bump 41a at the lower end. The bump 41a has a shape that increases its diameter toward the planar antenna member 31 to uniformly and efficiently propagate microwaves in the horizontal direction. Consequently, microwaves are efficiently propagated through the inner conductor 41 and bump 41a of the coaxial wave guide tube 37a to the planar antenna member 31

The respective components of the plasma processing apparatus 100 are connected to and controlled by a process controller 50 disposed in a control section 101. The process controller 50 is connected to a user interface 51 including, e.g. a keyboard and a display, wherein the keyboard is used for a process operator to input commands for operating the plasma processing apparatus 100, and the display is used for showing visualized images of the operational status of the plasma processing apparatus 100.

Further, the process controller 50 is connected to a storage portion 52 that stores recipes containing control programs, process condition data, and so forth recorded therein, for the process controller 50 to control the plasma processing apparatus 100 so as to perform various processes.

A required recipe is retrieved from the storage portion 52 and executed by the process controller 50 in accordance with an instruction or the like input through the user interface 51. Consequently, the plasma processing apparatus 100 can perform a predetermined process under the control of the process controller 50. The recipes containing control programs and process condition data may be used while they are stored in a computer readable storage medium, such as a CD-ROM, hard disk, flexible disk, or flash memory. Alternatively, the recipes may be used online while they are transmitted from another apparatus through, e.g., a dedicated line, as needed.

In the plasma processing apparatus 100 of the RLSA type thus arranged, curing of a Low-k film formed on a wafer W is performed in the following sequence. For example, a Low-k film set as a curing target object may be a Low-k film of the SiOCH family formed by, e.g. a CVD method or coating method. Particularly, where the plasma processing apparatus 100 according to this embodiment is used to perform curing of a porous Low-k film of the SiOCH family, the hardness of the film can be improved without increasing the dielectric constant thereof; which is very advantageous. The apparatus 100 may be used for curing of another Low-k material of, e.g., the porous silica family, CF family, organic polymer family, MSQ (Methylsilsesquioxane), or porous MSQ.

At first, the gate valve 26 is opened, and a wafer W is transferred through the transfer port 25 into the chamber 1 and is placed on the susceptor 2. Then, Ar gas and H₂ gas are supplied at predetermined flow rates from the Ar gas supply source 17 and H₂ gas supply source 18 in the gas supply system 16 through the gas introducing member 15 into the chamber 1, while it is maintained at a predetermined pressure. For example, preferable plasma process conditions may be selected from an Ar gas flow rate of 50 to 1,000 mL/min, an H₂ gas flow rate of 50 to 1,000 mL/min, a pressure of 100 mTorr to 10 Torr, a microwave power of 0.5 to 5 kW, and a temperature of 25 to 500° C.

Then, microwaves are supplied from the microwave generation unit 39 through the matching circuit 38 into the wave guide tube 37. The microwaves are supplied through the rectangular wave guide tube 37b, mode transducer 40, and coaxial wave guide tube 37a in this order to the planar antenna member 31. Then, the microwaves are radiated from the planar antenna member 31 through the microwave transmission plate 28 into the space above the wafer W within the chamber 1. The microwaves are propagated in a TE mode through the rectangular wave guide tube 37b, and are then transduced from the TE mode into a TEM mode by the mode transducer 40 and propagated in the TEM mode through the coaxial wave guide tube 37a to the planar antenna member 31.

When the microwaves are radiated from the planar antenna member 31 through the microwave transmission plate 28 into the chamber 1, the Ar gas and H₂ gas are turned into plasma inside the chamber 1, by which a curing process is performed on the Low-k film on the wafer W. This microwave plasma has a plasma density of about 1×10¹¹/cm³ or more and a low electron temperature of about 1.5 eV or less near the wafer W. Accordingly, the curing process can be performed at a low temperature and in a short time, and the underlying film can suffer less plasma damage due to ions and so forth. Further, the upper plate 60 and lower plate 61 are disposed double as a selection passage implement for preventing ions in plasma from passing therethrough and for preferentially allowing hydrogen radicals to pass therethrough. Consequently, the process can be performed in a state where the energy of ions in plasma is decreased to minimize the influence of ions.

Next, an explanation will be given of an effect of the present invention with reference to FIG. 5. FIG. 5 is a principle view schematically showing a curing process of a wafer W according to an embodiment, performed in the plasma processing apparatus 100. In the plasma processing apparatus 100, microwaves supplied from the planar antenna member 31 act on Ar/H₂ gas and thereby generate plasma, which falls down within the chamber 1 toward a wafer W placed on the susceptor 2. The overlapped upper plate 60 and lower plate 61 engage with the falling plasma and preferentially allow radicals in the plasma to pass therethrough.

Specifically, as shown in FIG. 5, ions, such as monovalent argon ions (Ar⁺) and hydrogen ions (H⁺), and electrons (e⁻) contained in plasma are charged particles. Accordingly, they can hardly pass through the upper plate 60 and lower plate 61 made of an insulative material, such as quartz, and thus they are partly or mostly deactivated. On the other hand, hydrogen radicals (H*) are neutral particles, and thus they can pass through the through holes 60a and 61a and reach the wafer W. In order to cut off ions in plasma, it is important to arrange the two plates in an overlapped state, in which the through holes 61a of the lower plate 61 and the through holes 60a of the upper plate 60 are positionally shifted from each other to prevent them from being aligned (see FIGS. 2 and 3). The through holes 60a and 61a thus arranged can block off the passage of ions in plasma, thereby decreasing the number of ions reaching the wafer W, while preferentially allowing hydrogen radicals to pass therethrough.

Hydrogen radicals having passed through the upper and lower plates 60 and 61 act on a Low-k film on the wafer W, and thereby cure the film. At this time, ions that may increase the dielectric constant of the Low-k film have been eliminated. Consequently, it is possible to cure the film while maintaining a good film quality without increasing the dielectric constant. This effect is prominent where a porous Low-k film is processed.

Next, an explanation will be given of experimental data used as the basis for the present invention, with reference to FIG. 6. FIG. 6 is a graph showing the relationship between the dielectric constant and elasticity modulus of an SiOCH family Low-k film, where the film was cured by a plasma process in a plasma processing apparatus 100 having the same structure as shown in FIG. 1. In the graph of FIG. 6, the vertical axis denotes the elasticity modulus (GPa) for 15% of the film thickness, while the horizontal axis denotes the dielectric constant. In the plasma process conditions, the process gas was Ar/H₂ set at a flow rate ratio of 50/500 mL/min (sccm), the wafer temperature at 400° C., the pressure at about 400 Pa (3 Torr), the plasma supply power at 2 kW, and the process time at 60 to 600 seconds.

FIG. 6 shows a result (line A) obtained by the plasma processing apparatus according to the present invention, along with a result (line B) and a result (line C) both obtained by use of a conventional plasma processing apparatus having the same structure as the plasma processing apparatus 100 except that the upper and lower plates 60 and 61 were not used, for comparison. In one comparison case (line B), a process was performed under the same plasma process conditions as those described above. In another comparison case (line C), a process was performed under conditions using a low pressure (6.7 Pa; the other conditions were the same as those described above), so that ions was predominant in plasma.

As shown in FIG. 6, in the case of one result (line B) obtained by the conventional plasma processing apparatus, the dielectric constant was increased with an increase in the elasticity modulus of the Low-k film. Accordingly, it is understandable that the hardening and dielectric constant decreasing of the film have a trade-off relationship. This tendency became prominent in the other result (line C) obtained by the conventional plasma processing apparatus, where the ion ratio in plasma was set higher by conditions using a low pressure.

On the other hand, in the case of the curing process performed by the plasma processing apparatus 100 provided with the upper and lower plates 60 and 61, the elasticity modulus of the film was increased while a low dielectric constant was maintained, as indicated by the line A.

From the results described above, it has been confirmed that, where the plasma processing apparatus 100 is provided with the upper and lower plates 60 and 61 to block off the passage of ions and to preferentially allow hydrogen radicals to pass therethrough, the influence of ions can be removed or decreased in the curing process, so that a Low-k film is reliably cured.

In this respect, in the process of curing a Low-k film, high density plasma generated in the plasma processing apparatus 100 and including hydrogen radicals mainly causes the quality of the surface layer of the film to be dense and hardened, while a nondense layer is left on the lower side in the film. During irradiation with plasma, reactions are caused by radicals having certain energy, such as H radicals, such that Si—CHx bonds forming the Low-k film are cut and CHx is thereby removed, and Si—OH bonds of other molecules are similarly cut. Consequently, molecules, such as CHx and OH, in the Low-k film are removed, and a molecule structure having a ladder shape (ladder structure) is formed on the basis of CH₃—Si—O, along with spaces among molecules. In the process of these reactions, where the plasma processing apparatus 100 provided with the double plates 60 and 61 as a radical selection passage implement is used, the influence of ions are decreased. In this case, a mild reaction can be obtained such that it proceeds moderately without excessively detaching methyl groups or the like, as described above. Consequently, polarization of molecules in the Low-k film is suppressed, so the film is cured while a low dielectric constant k is maintained.

Next, an explanation will be given of an example of a plasma processing system including the plasma processing apparatus 100, which can continuously perform processes from formation of a Low-k film to curing of the film. As shown in FIG. 7, this processing system 200 includes a plurality of, e.g., four, process chambers 204A, 204B, 204C, and 204D, a common transfer chamber 206 having an essentially hexagonal shape, first and second load-lock chambers 208A and 208B having a load-lock function, and a laterally long I/O transfer chamber 210. Specifically, the process chambers 204A to 204D are respectively connected to four sides of the common transfer chamber 206 having an essentially hexagonal shape, and the first and second load-lock chambers 208A and 208B are respectively connected to the other two sides. The first and second load-lock chambers 208A and 208B are connected to the I/O transfer chamber 210 in common.

The common transfer chamber 206 is connected to the four process chambers 204A to 204D and first and second load-lock chambers 208A and 208B respectively through gate valves G, which can be airtightly opened/closed. In other words, the processing system 200 has a structure of the cluster tool type, in which the chambers 204A to 204D and 208A and 208B can communicate with the common transfer chamber 206, as needed. The first and second load-lock chambers 208A and 208B are connected to the I/O transfer chamber 210, also respectively through gate valves G, which can be airtightly opened/closed.

The four process chambers 204A to 204D are respectively provided with susceptors 212A to 212D therein, for placing a target object or semiconductor wafer thereon. The process chambers 204A to 204D are designed to perform processes of the same kind or different kinds on a target object or semiconductor wafer W. For example, the process chambers 204A and 204B are arranged to perform a film formation process of a Low-k film by use of a plasma CVD apparatus 300 of the parallel-plate type (see FIG. 8), as described later. The process chambers 204C and 204D are arranged to perform a curing process of a Low-k film by use of the plasma processing apparatus 100 of the RLSA type shown in FIG. 1 described above. The common transfer chamber 206 is provided with a second transfer mechanism 214 therein, which is formed of articulated arms and is extensible/contractible, movable up and down, and rotatable. The second transfer mechanism 214 is located at a position inside the common transfer chamber 206, where it can access each of the two load-lock chambers 208A and 208B and four process chambers 204A to 204D. The second transfer mechanism 214 has two picks B1 and B2, which are extensible/contractible independently of each other toward opposite directions, so that it can handle two wafers at a time. The second transfer mechanism 214 may be designed to have only one pick.

The I/O transfer chamber 210 is formed of a laterally long casing. On one side of this laterally long casing, one or more e.g., three in this embodiment, transfer ports 216 are formed, for transferring a target object or semiconductor wafer W therethrough. The transfer ports 216 are respectively provided with opening/closing doors 221 for opening/closing the transfer ports 216. Further, the transfer ports 216 are respectively provided with I/O port portions 218A, 218B, and 218C each structured to place one cassette case 220 thereon. The cassette case 220 can accommodate a plurality of, e.g., 25, wafers with regular intervals therebetween in the vertical direction.

The I/O transfer chamber 210 is provided with an I/O transfer mechanism or first transfer mechanism 222 therein, which transfers wafers W in the longitudinal direction of the I/O transfer chamber 210. The first transfer mechanism 222 is slidably supported on a guide rail 224 extending in the longitudinal direction of the I/O transfer chamber 210 at the center portion. The guide rail 224 is provided with a driving mechanism, such as a linear motor built therein and including an encoder. The first transfer mechanism 222 is moved along the guide rail 224 by driving of the linear motor.

The first transfer mechanism 222 has two articulated arms 232 and 234 disposed at two height levels. The articulated arms 232 and 234 respectively include U-shaped picks A1 and A2 at the end, on which a wafer W is directly placed. The articulated arms 232 and 234 are configured to be extensible/contractible in a radial direction from the center, and movable up and down. The articulated arms 232 and 234 can be independently controlled to perform an extending/contracting action.

The articulated arms 232 and 234 have rotary shafts coaxially and rotatably connected to a base 236. The articulated arms 232 and 234 can be rotated together relative to the base 236. The first transfer mechanism 222 may be designed to have only one pick in place of the two picks A1 and A2.

At one end of the I/O transfer chamber 210, there is an orientor 226 for performing alignment of a wafer. Further, at the middle in the longitudinal direction of the I/O transfer chamber 210, the two load-lock chambers 208A and 208B are connected to one side of the I/O transfer chamber 210 respectively through the gate valves G, which can be opened/closed.

The orientor 226 has a rotary table 228, which is rotated by a drive motor (not shown) along with a wafer W placed thereon. An optical sensor 230 for detecting the peripheral edge of a wafer W is disposed beside the rotary table 228. The optical sensor 230 can detect the positional direction of the positioning cut of the wafer W, such as a notch or orientation flat, and misalignment of the center of the wafer W.

The first and second load-lock chambers 208A and 208B are respectively provided with tables 238A and 238B therein, each having a diameter smaller than that of the wafer W and used for temporarily placing a wafer W thereon. A control section 101 including a process controller 50 (see FIG. 1) is arranged to control the operation of the processing system 200 as a whole, such as the operation of the transfer mechanisms 214 and 222 and the orientor 226.

Next, an explanation will be given of an example of a method for forming a Low-k film, with reference to FIG. 8. A Low-k film (which will be referred to as an SiOC family film hereinafter) formed in this explanation contains silicon (Si), oxygen (O) and carbon (C) as main components, and has pores uniformly in the thickness direction. This etching apparatus shown in FIG. 8 is structured as a plasma CVD apparatus of the so-called parallel-plate type, which includes upper and lower electrodes facing to each other in parallel, to form an SiOC family film by CVD on the surface of a semiconductor wafer (which will be referred to as a wafer W, hereinafter). This plasma CVD apparatus 300 of the parallel-plate type includes a cylindrical chamber 312. The chamber 312 is made of a conductive material, such as alumite processed (anodization processed) aluminum. The chamber 312 is grounded.

An exhaust port 313 is formed at the bottom of the chamber 313, and is connected to an exhaust unit 314, which includes a vacuum pump, such as a turbo molecular pump. The exhaust unit 314 can exhaust the interior of the chamber 312 to a predetermined pressure. The chamber 312 is provided with a gate valve 315 on a sidewall. The wafer W is transferred between the inside and outside of the chamber 312 through the gate valve 315 in the open state. A detoxification unit 336 is disposed to detoxify the gas or atmosphere exhausted by the exhaust unit 314 from inside the chamber 312. The detoxification unit 336 is configured to burn or thermally decompose the gas or atmosphere and change it into harmless substances by use of a predetermined catalyst.

An essentially columnar susceptor pedestal 316 is disposed on the bottom of the chamber 312. A susceptor 317 is supported on the susceptor pedestal 316 and is used as a table for the wafer W. The susceptor 317 serves as a lower electrode and is insulated from the susceptor pedestal 316 by an insulative material 318, such as a ceramic, interposed therebetween. The susceptor pedestal 316 is provided with a lower coolant passage 319 formed therein to circulate a coolant. A coolant is circulated through the lower coolant passage 319 to control the susceptor 317 and wafer W to be a predetermined temperature.

Lifter pins 320 are disposed inside the susceptor pedestal 316 to transfer the wafer W. The lifter pins 320 are configured to be moved up and down by a cylinder (not shown). The center of the top of the susceptor 317 is projected in a circular plate shape, on which an electrostatic chuck (not shown) is disposed and has essentially the same shape as the wafer W. When a DC (direct current) voltage is applied to the electrostatic chuck, the wafer W placed on the susceptor 317 is attracted and held by an electrostatic attraction force. The susceptor 317 serving as a lower electrode is connected to a first RF (radio frequency) power supply 321 through a first matching unit 322. The first RF power supply 321 outputs an RF power with a frequency within a range of 450 kHz to 60 MHz, which is to be applied to the susceptor 317.

A showerhead 323 is disposed above the susceptor 317 and faces the susceptor 317 in parallel therewith. The surface of the showerhead 323 facing the susceptor 317 is formed by an electrode plate 325 made of, e.g., aluminum and having a number of gas holes 324 formed therein. The showerhead 323 is supported by the ceiling portion of the chamber 312 through an electrode support body 326. The showerhead 323 is provided with an upper coolant passage 327 formed therein. A coolant is circulated through the upper coolant passage 327 to control the showerhead 323 to be a predetermined temperature.

The showerhead 323 is connected by a gas feed line 328 to a source 329 of 1,3,5-trimethyl-1,3,5-trivinylcyclotrisiloxane (V3D3) gas, a source 330 of isopropyl alcohol (IPA) gas, and a source 331 of argon (Ar) gas, through mass-flow controllers and valves (they are not shown). Since V3D3 and IPA are in a liquid phase at room temperature, they are vaporized by a heating portion (not shown) and then supplied to the gas sources 329 and 330. The gas feed line 328 is further connected to a source 335 of NH₃ gas used as a process gas for forming pores, through a mass-flow controller and valves (they are not shown).

The source gases and process gas from the gas sources 329 to 331 and 335 are supplied in a mixed state through the gas feed line 328 into a hollow (not shown) formed inside the showerhead 323. The gases supplied into the showerhead 323 are distributed in the hollow, and then supplied from the gas holes 324 of the showerhead 323 onto the surface of the wafer W.

The showerhead 323 is connected to a second RF power supply 332 through a feed line provided with a second matching unit 333. The second RF power supply 332 outputs an RF power with a frequency within a range of, e.g., 450 kHz to 150 MHz. Where an RF power with such a high frequency is applied to the showerhead 323 serving as an upper electrode, high density plasma can be generated in a preferable dissociation state within the chamber 312.

The control section 101 is arranged to control the operation of the plasma CVD apparatus 300 of the parallel-plate type as a whole, including an operation for a film formation process performed on the wafer W. As described previously the control section 101 uses a storage portion 52 (see FIG. 1) to store a program for controlling the respective portions of the apparatus in accordance with a predetermined process sequence. The control section 101 transmits control signals to the respective portions of the apparatus in accordance with this program.

Next, an explanation will be given of a method for forming an insulating film in the plasma CVD apparatus 300 of the parallel-plate type. At first, an unprocessed wafer W is held by an articulated arm of the second transfer mechanism 214 (see FIG. 7), and is transferred into the chamber 312 through the gate valve 315 in the open state. The transfer arm delivers the wafer W onto the lifter pins 320 set at the upper position, and then retreats from the chamber 312. Then, the lifter pins 320 are moved down, so that the wafer W is placed on the susceptor 317. The wafer W is fixed on the susceptor 317 by the electrostatic chuck.

Then, the pressure inside the chamber 312 is decreased by the exhaust unit 314 to, e.g., 50 Pa (3.8×10⁻¹ Torr). At the same time, the temperature of the susceptor 317 is set to be 400° C. or less, such as 300° C.

Thereafter, V3D3, IPA, and Ar gases are supplied from the gas sources 329 to 331 at predetermined flow rates into the chamber 312. A mixture gas of the process gases is uniformly delivered from the gas holes 324 of the showerhead 323 toward the wafer W. For example, V3D3, IPA and Ar gases are supplied at a flow rate ratio of V3D3/IPA/Ar=30/10/100 (sccm).

Thereafter, an RF power with, e.g., 27 MHz is applied from the second RF power supply 332 to the upper electrode (showerhead 323). Consequently, an RF electric field is formed between the upper electrode and lower electrode (susceptor 317), and plasma of the mixture gas is thereby generated. On the other hand, an RF power with, e.g., 2 MHz is applied from the first RF power supply 321 to the lower electrode. With this RF power being applied, charged particles in the generated plasma, and particularly molecular radicals of V3D3 and IPA, are attracted toward the surface of the wafer W and cause a reaction near the surface. Consequently, an SiOC family film containing IPA molecules is thereby formed on the surface of the wafer W.

At this time, the RF powers are applied to the upper and lower electrodes 323 and 317 for several seconds to several ten seconds to form an SiOC family film having a thickness of, e.g., 50 nm (500 Å) on the surface of the wafer W. When a predetermined time has elapsed from the start of the RF power application the RF power application to the upper electrode and lower electrode is stopped and the supply of V3D3 and IPA from the V3D3 gas source 329 and IPA gas source 330 is stopped. With the operations described above, the film formation process is temporarily stopped. At this time, Ar is being supplied into the chamber 312.

The interior of the chamber 312 is purged by Ar gas for a predetermined time to remove the residual part of V3D3 and IPA from inside the chamber 312.

In this case, the porosity of the film can be improved by performing an NH₃ plasma annealing process after the film formation process. Accordingly, the film formation process and plasma annealing process with purging period interposed therebetween are repeated to form an SiOC family multi-layered film having a thickness of, e.g., 500 nm (5,000 Å). After the film is formed, heating of the susceptor 317 is stopped, and the pressure inside the chamber 312 is returned to a value close to the pressure outside the chamber 312. Then, the electrostatic chuck is disabled, and the lifter pins 320 are moved up. Then, the gate valve 315 is opened, and a transfer arm of the second transfer mechanism 214 enters the chamber 312. Then, the wafer W is transferred by the transfer arm of the second transfer mechanism 214 out of the chamber 312

In the embodiment described above, V3D3 and IPA are used as source compounds to form an SiOC family film as an insulating film, but other source materials may be used. For example, an alternative to V3D3 is a cyclic siloxane compound, such as oktamethylcyclotetrasiloxane (D4), hexaethylcyclotrisiloxane, hexamethylcyclotrisiloxane, oktaphenylcyclotrisiloxane, or tetraethylcyclotetrasiloxane, or another organic silane gas, such as trimethylsilane or dimethyldimethoxysilane (DMDMOS). The insulating film is not limited to an SiOC family film, and, for example, it may be a low dielectric constant organic film, such as MSQ, porous MSQ, or organic polymer, formed by a CVD method or coating method, or a low dielectric constant inorganic film, such as SiC, SiN, SiCN, SiOF, or SiOx.

As described above, the plasma processing system 200 includes the plasma CVD apparatus 300 of the parallel-plate type used as a film formation apparatus, and the plasma processing apparatus 100 used as a curing apparatus. Accordingly, the plasma processing system 200 can continuously perform processes from formation of a Low-k film or insulating film to curing of the film.

The present invention has been described with reference to the embodiments, but the present invention is not limited to the embodiments described above, and it may be modified in various manners.

For example, in FIG. 1, the plasma processing apparatus 100 of the RLSA type is shown as an example. However, as long as an apparatus is structured to supply plasma toward a target substrate in a certain direction, the two plates 60 and 61 disposed at this portion can provide the same effect as described above. Accordingly, the plasma processing apparatus may be of another type, such as the remote plasma type, ICP type, ECR type, surface reflection wave type, parallel-plate (electric capacitance) type, or magnetron type.

The number of plates is not limited two, and three or more plates may be disposed in an overlapped state, as needed.

The shape of the through holes 60a and 61a is not limited to a circular shape, and it may be another shape, such as a rectangular shape. Further, as shown in FIG. 9, an upper plate 62 and a lower plate 63 are arranged such that they have slits 62a and 63a positionally shifted from each other.

The opening area and ratio of the through holes 60a and 61a or slits 62a and 63a can be suitably adjusted in accordance with the type of a Low-k film to be cured and plasma process conditions.

### INDUSTRIAL APPLICABILITY

The present invention can be preferably utilized for manufacturing various semiconductor devices, such as logic devices.

1. A plasma processing apparatus comprising:
a process chamber configured to perform a plasma process on a target substrate;
a substrate table configured to place the target substrate thereon inside the process chamber; and
a selection passage implement disposed above the substrate table and configured to suppress passage of ions in plasma and preferentially allow hydrogen radicals in the plasma to pass therethrough.

2. The plasma processing apparatus according to claim 1, wherein plasma is supplied from an upper position inside the process chamber through the selection passage implement toward the target substrate placed on the substrate table.

3. The plasma processing apparatus according to claim 1, wherein the selection passage implement includes two or more plates each having a plurality of through openings formed therein, the plates being arranged such that the through openings of the plates are not aligned with each other.

4. The plasma processing apparatus according to claim 3, wherein the through openings are through holes or slits.

5. The plasma processing apparatus according to claim 3, wherein each of the plates is formed of an insulative material.

6. A plasma processing apparatus comprising:
a process chamber configured to perform a plasma process on a target substrate;
a substrate table configured to place the target substrate thereon inside the process chamber; and
two or more plates disposed above the substrate table and each having a plurality of through openings formed therein, the plates being arranged such that the through openings of the plates are not aligned with each other.

7. The plasma processing apparatus according to claim 6, wherein plasma is supplied from an upper position inside the process chamber through the plates toward the target substrate placed on the substrate table.

8. The plasma processing apparatus according to claim 6, wherein the through openings are through holes or slits.

9. The plasma processing apparatus according to claim 6, wherein each of the plates is formed of an insulative material.

10. A plasma processing apparatus comprising:
a process chamber configured to perform a plasma process on a target substrate;
a substrate table configured to place the target substrate thereon inside the process chamber; and
an exhaust system configured to decrease pressure inside the process chamber;
a gas supply system configured to supply a gas into the process chamber;
a planar antenna disposed at an upper position of the process chamber and connected to a microwave generation unit outside the process chamber, the planar antenna having a plurality of slots formed therein to supply microwaves into the process chamber to generate plasma; and
two or more plates disposed between the planar antenna and the substrate table and each having a plurality of through openings formed therein the plates being arranged such that the through openings of the plates are not aligned with each other.

11. The plasma processing apparatus according to claim 10, wherein plasma is supplied from an upper position inside the process chamber through the plates toward the target substrate placed on the substrate table.

12. The plasma processing apparatus according to claim 10, wherein the through openings are through holes or slits.

13. The plasma processing apparatus according to claim 10, wherein each of the plates is formed of an insulative material.

14. A plasma processing method performed in a plasma processing apparatus configured to perform a plasma process on a target substrate placed on a substrate table inside a process chamber, the method comprising:
supplying plasma from an upper position inside the process chamber toward the target substrate placed on the substrate table, while using a selection passage implement disposed above the substrate table to suppress passage of ions in the plasma and preferentially allow hydrogen radicals in the plasma to pass therethrough.

15. The plasma processing method according to claim 14, wherein the plasma process is arranged to preferentially cause hydrogen radicals to act on a Low-k film formed on the target substrate, thereby performing a hardening process on the Low-k film.

16. The plasma processing method according to claim 15, wherein the Low-k film is an SiOCH family film.

17. The plasma processing method according to claim 15, wherein a process gas containing a rare gas and hydrogen is used.

18. A control program for execution on a computer, used for a plasma processing apparatus configured to perform a plasma process on a target substrate placed on a substrate table inside a process chambers wherein the control program, when executed by the computer, controls the apparatus to perform a plasma processing method comprising:
supplying plasma from an upper position inside the process chamber toward the target substrate placed on the substrate table, while using a selection passage implement disposed above the substrate table to suppress passage of ions in the plasma and preferentially allow hydrogen radicals in the plasma to pass therethrough; and
preferentially causing hydrogen radicals to act on a Low-k film formed on the target substrate, thereby performing a hardening process on the Low-k film.

19. A computer storage medium that stores a control program for execution on a computer, used for a plasma processing apparatus configured to perform a plasma process on a target substrate placed on a substrate table inside a process chamber, wherein the control program, when executed by the computer, controls the apparatus to perform a plasma processing method comprising:
supplying plasma from an upper position inside the process chamber toward the target substrate placed on the substrate tables while using a selection passage implement disposed above the substrate table to suppress passage of ions in the plasma and preferentially allow hydrogen radicals in the plasma to pass therethrough; and
preferentially causing hydrogen radicals to act on a Low-k film formed on the target substrate, thereby performing a hardening process on the Low-k film.

20. A plasma processing apparatus comprising:
a process chamber configured to be vacuum-exhausted and to perform a process on a target substrate by use of plasma;
a substrate table configured to place the target substrate thereon inside the process chamber;
a selection passage implement disposed above the substrate table and configured to suppress passage of ions in the plasma and preferentially allow hydrogen radicals in the plasma to pass therethrough; and
a control section configured to perform a plasma processing method for preferentially causing hydrogen radicals to act on a Low-k film formed on the target substrate, thereby performing a hardening process on the Low-k film.
